(19) United States
(12) Patent Application Publication
(10) Pub. No.: US 2003/0005691 A1
(43) Pub. Date: Jan. 9, 2003

(54) Controller for construction equipment

(76) Inventors: Ikuo Kita, Hirakata-City (JP); Yuuichi Nagahiro, Katano-City (JP); Hiroshi Nakagami, Hirakata-City (JP)

Correspondence Address: VARNDELL & VARNDELL, PLLC, 106-A S. COLUMBUS ST., ALEXANDRIA, VA, 22314, US

(21) Appl. No.: 10/180,296

(22) Filed: Jun. 27, 2002

(30) Foreign Application Priority Data
Jul. 9, 2001 (JP) 2001-207371

(51) Int. Cl. F16D 31/02

(52) U.S. Cl. 60/451

(57) ABSTRACT

Disclosed is a controller for construction equipment, which avoids occurrence of an engine stall even at the time of a heavy load while assuring simultaneous operation of a hydraulic actuator for a working machine and a hydraulic drive motor. The controller is provided with a torque variable control valve for controlling a pump maximum displacement so that a suction torque of a hydraulic pump becomes constant when a discharge oil pressure of the hydraulic pump exceeds a predetermined value; and a servo valve for changing the tilt angle of a cam plate of the hydraulic pump in accordance with an instruction from the torque variable control valve.

### BACKGROUND OF THE INVENTION

1. Field of the Invention

The present invention relates to a technique for assuring simultaneous operation of a hydraulic actuator for a working machine and a hydraulic drive motor in construction equipment such as a bulldozer.

2. Description of the Related Art

Conventionally, in construction equipment such as a bulldozer, to assure a hydraulic power required in the case where a work of a working machine such as a blade or ripper and steering of a vehicle are performed simultaneously, a system having two independent pumps (independent-two-pump system) of a hydraulic pump for a working machine for supplying a hydraulic power to a hydraulic actuator for a working machine and a hydraulic pump for steering, which supplies a hydraulic power to an HSS (Hydrostatic Steering System) motor (hydraulic drive motor) is employed (refer to Japanese Unexamined Patent Application No. Hei-11-181823).

There is also a case of employing a one-pump system for driving a hydraulic actuator for a working machine and an HSS motor by pressure oil discharged from a single hydraulic pump. In the case of the one-pump system, in order to prevent occurrence of engine stall at the time of simultaneously operating the hydraulic actuator for a working machine and the HSS motor, a hydraulic pump of a small displacement is used at the expense of the performance of the working machine and the steering performance.

However, in the case of employing the two-pump system, although the simultaneous operation of the hydraulic actuator for a working machine and the HSS motor can be assured, a charge pump is required in addition to the hydraulic pump for a working machine and the hydraulic pump for steering. It causes a problem such that not only the whole configuration of the system becomes complicated but also the cost increases.

On the other hand, in the case of the one-pump system, such a problem can be solved. However, as described above, only a hydraulic pump of a small displacement can be used in consideration of occurrence of engine stall at the time of simultaneous operation of the hydraulic actuator for a working machine and the HSS motor, so that deterioration in the performance of the working machine or the performance of steering cannot be avoided.

### SUMMARY OF THE INVENTION

The invention has been achieved to solve such problems and its object is to provide a controller for construction equipment, capable of avoiding occurrence of engine stall even at the time of a high load while assuring simultaneous operation of a hydraulic actuator for a working machine and a hydraulic drive motor.

To achieve the object, the present invention provides a controller for construction equipment including a hydraulic pump driven by an output of an engine, and a hydraulic actuator for a working machine and a hydraulic drive motor which are operated by pressure oil discharged from the hydraulic pump. The controller is characterized by including: a torque variable control valve for controlling a pump maximum displacement so that a maximum suction torque of the hydraulic pump becomes constant when a discharge oil pressure of the hydraulic pump exceeds a predetermined value; and a servo valve for changing an angle of a cam plate of the hydraulic pump in accordance with an instruction from the torque variable control valve.

In the invention, the torque variable control valve is provided so that the hydraulic pump does not absorb torque larger than the predetermined torque at the time of a heavy load, so that as a hydraulic pump for operating both the hydraulic actuator for a working machine and the hydraulic drive motor, a single hydraulic pump of a large displacement can be used. Therefore, at the time of a light load, even when the hydraulic actuator for a working machine and the hydraulic drive motor are simultaneously operated, a sufficient flow rate is supplied from the hydraulic pump of a large displacement. Consequently, the simultaneous operation can be assured and deterioration in the performance of the working machine and the steering performance can be prevented. On the other hand, at the time of a heavy load, the torque of the hydraulic pump is regulated to a predetermined value or less by the torque variable control valve, so that occurrence of engine stall can be prevented. In such a manner, the engine power is efficiently used, the performance of the working machine and the steering performance are not sacrificed and, moreover, occurrence of engine stall can be avoided. Although the pump displacement is regulated at the time of a heavy load, since speed is not required, no problem occurs.

According to the invention, preferably, the controller for construction equipment further includes a load sensing valve for controlling a pump discharge so that a differential pressure between the discharge oil pressure of the hydraulic pump and a load pressure becomes constant, and the angle of the cam plate of the hydraulic pump is changed in accordance with an instruction of the load sensing valve. With the configuration, according to a load pressure generated by the driving of the hydraulic actuator for a working machine and the hydraulic drive motor, in other words, according to an oil pressure required by the hydraulic pump, the discharge of the hydraulic pump can be controlled to a proper value.

### BRIEF DESCRIPTION OF THE DRAWINGS

FIG. 1 is an outside drawing of a bulldozer according to an embodiment of the invention;

FIG. 2 is a diagram showing a power transmission system of the embodiment;

FIG. 3 is a block diagram schematically showing a hydraulic circuit of the embodiment; and

FIG. 4(a) is a characteristic diagram of a load sensing valve, and FIG. 4(b) is a characteristic diagram of a torque variable control valve.

### DETAILED DESCRIPTION OF THE INVENTION

A concrete embodiment of a controller for construction equipment according to the invention will be described hereinbelow with reference to the drawings.

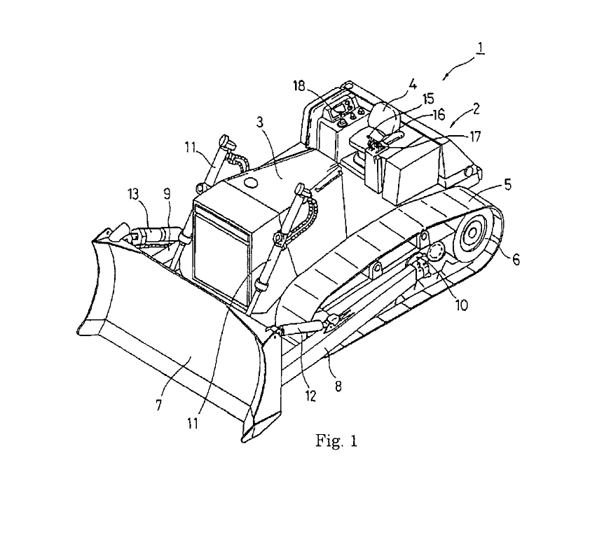

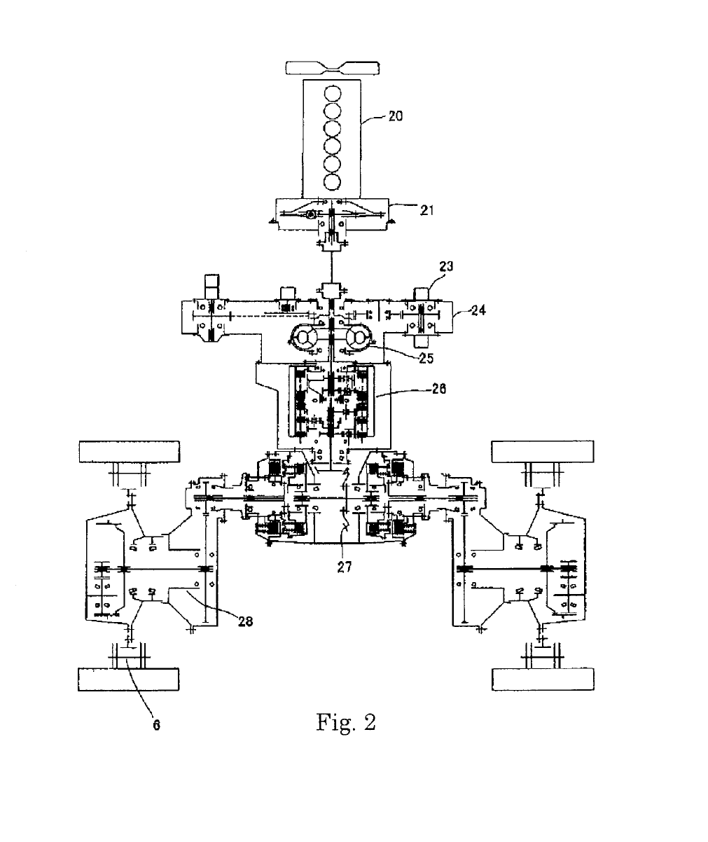

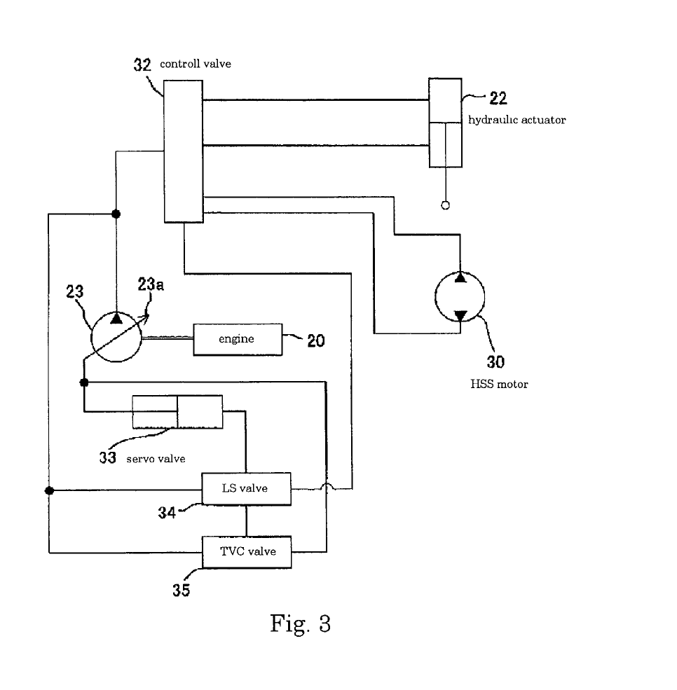

FIG. 1 is an outside diagram of a bulldozer according to an embodiment of the invention. FIG. 2 shows a power transmission system in the bulldozer of the embodiment. FIG. 3 is a block diagram schematically showing a hydraulic circuit.

In a bulldozer 1 of this embodiment, a bonnet 3 and a driver's seat 4 are provided on a vehicle body 2. On each of the right and left sides in the forward travel direction of the body 2, a crawler 5 for making the vehicle body 2 travel forward or backward or turn is provided. Each of the crawlers 5 is driven independently by a corresponding sprocket 6 by a driving force transmitted from an engine 20 which will be described hereinlater.

On the right and left sides of the vehicle body 2, the proximal portions of right and left straight frames 9 and 8 for supporting a blade 7 by their tip sides are pivoted by trunnions 10 (the right-side trunnion is not illustrated) so that the blade 7 is movable in the vertical direction. The blade 7 is provided by disposing a pair of right and left blade lift cylinders 11 and 11 for lifting the blade 7 between the blade 7 and the vehicle body 2, providing a brace 12 between the blade 7 and the left straight frame 8, and providing a blade tilt cylinder 13 between the blade 7 and the right straight frame 9. The brace 12 and the blade tilt cylinder 13 are used for tilting the blade 7 to the right or left.

On the left side of the driver's seat 4, a steering lever 15, a gear shift lever 16, and a fuel control lever 17 are provided. On the right side of the driver's seat 4, a blade control lever 18 for lifting and tilting the blade 7, and the like are provided. A not-shown decelerator pedal is provided in front of the driver's seat 4.

As shown in FIG. 2, torque from the engine 20 is transmitted to a torque converter 25 via a damper 21 and a PTO (Power Take-Off) 24 for driving a variable displacement hydraulic pump 23 for supplying pressure oil to a hydraulic actuator 22 (refer to FIG. 3) for a working machine such as the blade lift cylinder 11 and an HSS motor (hydraulic drive motor) 30 which will be described hereinlater. The torque is transmitted from the output shaft of the torque converter 25 to a transmission 26 such as a planetary-gear wet-type multiple-disc clutch transmission whose input shaft is coupled to the output shaft of the torque converter 25. The transmission 26 has forward and backward clutches and first to third speed clutches, and the output shaft of the transmission 26 is rotated at three levels in each of the forward and backward travels. Subsequently, the torque is transmitted from the output shaft of the transmission 26 to a pair of right and left final reduction gears 28 via a bevel gear 27 and a differential planetary gear unit to thereby drive each of the sprockets 6 for making the crawlers 5 drive.

As shown in FIG. 3, in the embodiment, to supply pressure oil to each of the hydraulic actuator 22 for a working machine and the HSS motor 30, the hydraulic pump 23 driven by the engine 20 is provided, and an controll valve 32 is provided on the discharge side of the hydraulic pump 23.

To the hydraulic pump 23, a servo valve (servo piston) 33 for variably driving the tilt angle of a pump cam plate 23a is connected. By changing the tilt angle of the pump cam plate 23a by the servo valve 33, the discharge oil amount per rotation can be changed. A load sensing (LS) valve 34 is disposed on the upstream side of the servo valve 33, and a torque variable control (TVC) valve 35 is disposed on the upstream side of the load sensing valve 34.

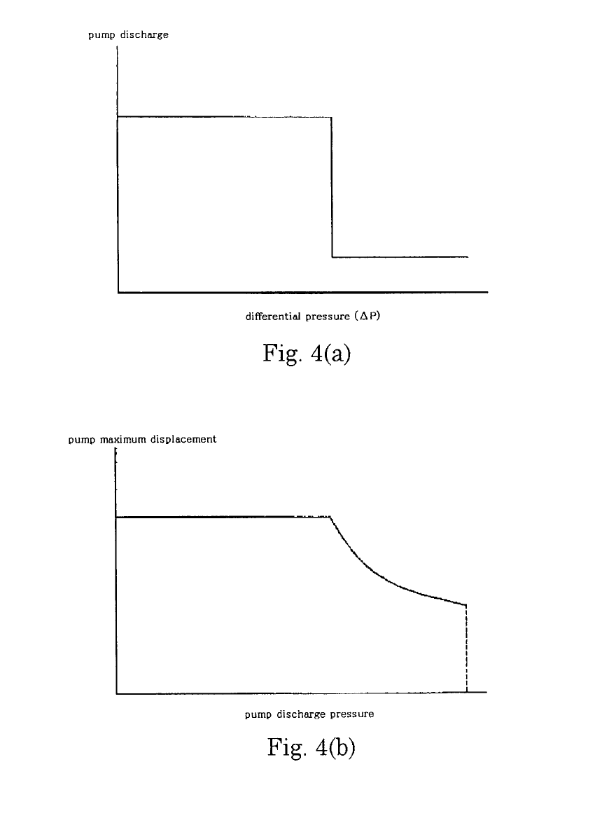

As shown in the characteristic diagram of FIG. 4(a), a load pressure generated by the driving of the hydraulic actuator 22 for a working machine and the HSS motor 30 is led to one end of the load sensing valve 34, and a discharge pressure of the hydraulic pump 23 is led to the other end. The load pressure and the pump discharge pressure are compared with each other, pressure oil is supplied to the servo valve 33 so that the pump discharge pressure is always higher than the load pressure only by a set differential pressure ΔP, and displacement of the hydraulic pump 23 is controlled. That is, when the pump discharge pressure is higher than the load pressure, the tilt angle of the cam plate 23a of the hydraulic pump 23 is decreased and the displacement of the hydraulic pump 23 is reduced. On the contrary, in the case where the pump discharge pressure is lower than the load pressure, the tilt angle of the cam plate 23a of the hydraulic pump 23 is increased and the displacement of the hydraulic pump 23 is increased. In such a manner, the pump discharge is controlled so that the differential pressure ΔP between the pump discharge pressure and the load pressure is a constant value (for example, 20 kg/cm²).

The upper limit value of the load pressure is regulated by a not-illustrated relief valve. Therefore, when the pump discharge pressure exceeds a predetermined cut-off pressure, the tilt angle of the cam plate 23a of the hydraulic pump 23 is operated so as to be reset to the minimum position, and the pump discharge is sharply decreased.

On the other hand, the tilt angle of the cam plate 23a of the hydraulic pump 23 is led to one end of the torque variable control valve 35, and the discharge pressure of the hydraulic pump 23 is led to the other end, and the pump maximum displacement is controlled to a value appropriate to the pump discharge pressure on the basis of balance between the tilt angle and the pump discharge. To be specific, as shown in the characteristic diagram of FIG. 4(b), at the time of a light load where the pump discharge pressure is relatively low, an instruction of a pump displacement request value is given to the servo valve 33 to thereby assure a sufficiently high pump flow rate. At the time of a heavy load where the pump discharge pressure exceeds a predetermined value, the pump maximum displacement is controlled to a value appropriate to the pump discharge pressure by an equal horsepower control. In other words, if the pump displacement request value is equal to or smaller than a pump displacement permissible value, the pump displacement request value is instructed to the servo valve 33. If there is a request exceeding the pump displacement permissible value, the pump displacement permissible value is instructed as a pump displacement to the servo valve 33.

In such a manner, at the time of the light load, even in the case where a high flow rate is requested from the hydraulic actuator 22 for a working machine and the HSS motor 30, sufficient pressure oil is supplied to both of them and the simultaneous operation is assured. On the other hand, at the time of the heavy load, a suction torque of the hydraulic pump 23 is regulated to a predetermined value or smaller so that the hydraulic pump 23 does not suck oil at not more than a predetermined horsepower, thereby enabling occurrence of engine stall from being prevented. As described above, the system of the embodiment has an excellent characteristic such that even when a single hydraulic pump 23 of a large displacement is used to supply pressure oil to both of the hydraulic actuator 22 for a working machine and the HSS motor 30, by efficiently using the engine power, occurrence of engine stall is prevented at the time of a heavy load and, moreover, simultaneous operation of the hydraulic actuator 22 for a working machine and the hydraulic motor 30 for driving can be assured at the time of a light load.

Particularly, in the bulldozer 1 as in the embodiment, in many times, the hydraulic actuator 22 for a working machine and the HSS motor 30 are simultaneously operated in such a manner that while performing a dozing (digging) work by the blade 7, the HSS motor 30 is operated to perform a steering operation. In this case, both of the performance of the working machine and the steering performance are not sacrificed. Consequently, it can be said the system is an extremely effective system. Although the pump displacement is regulated at the time of a heavy load, as speed is not required, no problem occurs.

Although a bulldozer has been described as an example in the embodiment, obviously, the invention can be applied to other construction equipment for performing a steering operation while operating a working machine.

What is claimed is:

1. A controller for construction equipment comprising a hydraulic pump driven by an output of an engine, and a hydraulic actuator for a working machine and a hydraulic drive motor which are operated by pressure oil discharged from the hydraulic pump, the controller comprising:
a torque variable control valve for controlling a pump maximum displacement so that a maximum suction torque of the hydraulic pump becomes constant when a discharge oil pressure of said hydraulic pump exceeds a predetermined value; and
a servo valve for changing an angle of a cam plate of said hydraulic pump in accordance with an instruction from the torque variable control valve.

2. The controller for construction equipment according to claim 1, further comprising a load sensing valve for controlling a pump discharge so that a differential pressure between the discharge oil pressure of said hydraulic pump and a load pressure becomes constant,
wherein the angle of the cam plate of said hydraulic pump is changed in accordance with an instruction of said load sensing valve.
